(19) United States
(12) Patent Application Publication
(10) Pub. No.: US 2014/0297303 A1
(43) Pub. Date: Oct. 2, 2014

(54) Method and Arrangement for the Optimized Setting of Medical Systems

(71) Applicants: Mirko Appel, Nurnberg (DE); Harald Hansen, Forchheim (DE)

(72) Inventors: Mirko Appel, Nurnberg (DE); Harald Hansen, Forchheim (DE)

(21) Appl. No.: 14/227,637

(22) Filed: Mar. 27, 2014

(30) Foreign Application Priority Data
Mar. 27, 2013 (DE) DE 102013205502.1

(51) Int. Cl. G06Q 50/22; G06Q 30/00

(52) U.S. Cl. CPC G06Q 50/22; G06Q 30/018
USPC 705/2

(57) ABSTRACT

A method and an associated arrangement for supporting a setting of a medical system are provided. The method includes entry of first requirement specification data relevant to a medical examination, transmission of the first requirement specification data to a central data analysis system, and acquisition of the first requirement specification data by the central data analysis system. The method also includes analysis of the first requirement specification data by a comparison with stored second requirement specification data. The method includes selection of best-fit first configuration data for setting the medical system based on the analysis, transmission of the first configuration data to the medical system, and display of the first configuration data on the medical system.

This application claims the benefit of DE 10 2013 205 502.1, filed on Mar. 27, 2013, which is hereby incorporated by reference in its entirety.

### FIELD

The present embodiments relate to supporting a setting of a medical system.

### BACKGROUND

In the case of diagnostic examinations using imaging medical systems (e.g., in angiography, computed tomography, fluoroscopy, molecular imaging or radiography), use is made of ionizing radiation, which may cause harm to the health of the patient. The strength of the radiation (e.g., the dose may be regulated by settings on the imaging system). The strength or dose of the radiation has great influence on the quality of the obtained image data, with the image quality increasing with a higher dose since the greater radiation intensity leads to images with lower noise.

Depending on the diagnostic question and on specific properties of the patient (e.g., body weight and body size), a parameterization of the medical system may therefore be selected such that the image quality is sufficient to answer the medical question, and the patient is not exposed to unnecessarily high radiation. As a result of the number of parameters to be taken into account, the parameterization or configuration of the medical system is very complicated and therefore also strongly dependent on the competence of the operating staff.

Many manufacturers of imaging systems distribute systems with a number of preconfigured protocols that are intended to provide that, in general, justifiable doses are used for specific standard examinations. The protocols, however, are not specifically adapted to individual patients or to every specific medical question.

Depending on the manufacturer, the application software includes various functions that enable the application software to adapt the dose individually or to emit warnings before specific limits are exceeded. There are offers for guidance services that school the clinical operating staff according to requirements and in a targeted manner in order to carry out the examinations with the lowest possible radiation dose.

The dose applied for an examination depends on the operation of the medical system and hence on the degree of education and the time outlay invested into the system configuration for an individual patient.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method with a medical system and an arrangement with a medical system, which simplify a setting of the medical system and optimize the setting for patients and imaging, are provided.

Central acquisition of configuration data, evaluation using cross comparison of a plurality of comparable examinations by a central analysis system, and subsequent transmission of a recommendation for a configuration to the medical system are provided. In contrast to software functions on the medical system itself, which have no access to a comparison database and merely correspond to the knowledge at the time of the development, one or more of the present embodiments allow the operating staff to profit from the current knowledge available in the database (e.g., continuous updating of the database) and to be able to use system configurations found to be “best practice”.

“Best practice” denotes reliable, optimum or ideal methods, practices or procedures in businesses or similar organizations.

One or more of the present embodiments provide a method for supporting a setting of a medical system (e.g., an x-ray device). The method includes entering first requirement specification data relevant to a medical examination, transmitting the first requirement specification data to a central data analysis system, acquiring the first requirement specification data by the central data analysis system, and analyzing the first requirement specification data by a comparison with stored second requirement specification data. The method also includes selecting best-fit first configuration data for setting the medical system based on the analysis, transmitting the first configuration data to the medical system, and displaying the first configuration data on the medical system.

An advantage offered by one or more of the present embodiments (e.g., in situations in which either the operating staff does not have the necessary competence or the necessary time for a careful configuration is not available) is that of obtaining a best possible system configuration for the specific examination at the touch of a button. Therefore, one or more of the present embodiments provide an adaptive medical system that may adapt itself in the best possible manner to patients and examinations.

In one development, the method also includes a setting of the medical system using the first configuration data after confirmation of the first configuration data by an operator of the medical system. This provides that the medical system is only set after approval by the operating staff.

In a further embodiment, the selection of the best-fit first configuration data may be from a plurality of second configuration data stored in the data analysis system. The first requirement specification data is compared to second requirement specification data and the associated second configuration data thereof.

Advantageously, evaluation data by experts in relation to the second requirement specification data and the second configuration data may be stored in the central data analysis system specifically for different medical examinations.

The first requirement specification data may include requirements for a medical examination to be carried out using the medical system.

In one embodiment, the first and second requirement specification data may include data with respect to the type of medical examination, with respect to the medical question, with respect to patient characteristics, such as age, weight, medical history, and with respect to an employed contrast agent.

Best-practice second configuration data evaluated by experts may be continuously transmitted to the central data analysis system.

In one embodiment, anonymized example images may be transmitted from the central data analysis system to the medical system. The example images represent the image quality to be expected for the first configuration data and impart an impression of image recording results to be expected.

One or more of the present embodiments provide an arrangement with a medical system and a central data analysis system for carrying out the method. The arrangement includes a database in the central data analysis system, in which the second requirement specification data and the second configuration data are stored.

In one development of the arrangement, the medical system may include an imaging device (e.g., an x-ray device).

### BRIEF DESCRIPTION OF THE DRAWINGS

FIG. 1 shows a flowchart of one embodiment of a method for optimized setting of a medical system; and

FIG. 2 shows a block diagram of one embodiment of an arrangement with a medical system and a central database.

### DETAILED DESCRIPTION

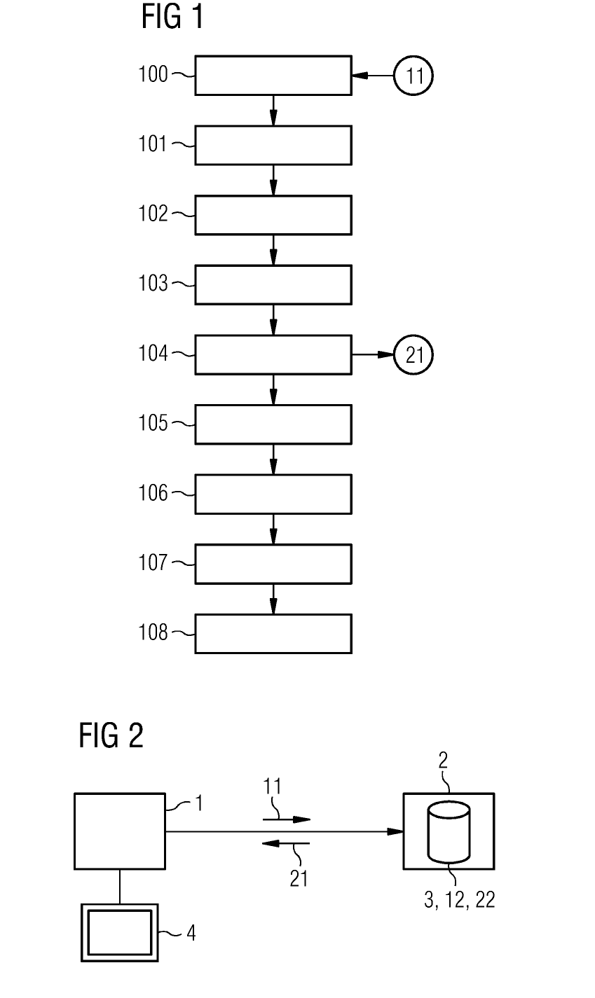

FIG. 1 shows a flowchart of a method according to one or more of the present embodiments for optimized setting of a medical system (e.g., of a computed tomography scanner). In act 100, the operating staff of the medical system enters first requirement specification data, relevant to a medical examination to be carried out on a patient, into the medical system. By way of example, first requirement specification data 11 is data with respect to the type of medical examination, with respect to the medical question, with respect to patient characteristics, such as age, weight or medical history, and with respect to an employed contrast agent.

In act 101, the first requirement specification data 11 is transmitted to a central data analysis system, where the first requirement specification data 11 is acquired in the act 102. In act 103, the first requirement specification data 11 is analyzed by comparison with stored second requirement specification data 12, where the first requirement specification data 11 is compared to the second requirement specification data 12, stored in the data analysis system, and the associated second configuration data 22 thereof.

In act 104, best-fit first configuration data 21 for setting the medical system is selected from a plurality of the second configuration data 22 based on the analysis in act 103. The first configuration data 21 thus selected is transmitted to the medical system in act 105 and displayed to the operating staff on a display unit of the medical system in act 106.

For safety reasons, the operating staff is to confirm the displayed first configuration data 21 in act 107 before, in act 108, the medical system is set by the first configuration data 21.

In other words, the method includes transmitting the requirements of a specific examination (e.g., the type of examination, the medical question, patient characteristics (age, weight, medical history), an employed contrast agent) to the central data analysis system electrically and acquiring the requirements at the central data analysis system. By analysis of the requirements and taking into account all boundary conditions of the specific examination, a recommendation for the optimum system configuration of the medical system is established.

A component of the data analysis system is a database, in which a large number of system configurations are stored together with the respective requirements on the specific examinations and the associated evaluations by experts. Hence, best-practice settings may be established from the database. The database is continuously updated by the transmission of further, improved system configurations based on experiences from leading clinical institutions.

The analysis includes establishing, using a comparison method, a system configuration in the best-practice database, which satisfies the requirements of the specific examination to the best possible extent.

If an appropriate system configuration may be established, the configuration is transmitted to the medical system. The suggestion is displayed to the operating staff, and the suggestion may be used for the examination by confirmation (e.g., by mouse click on an “apply” box).

If one or more configuration suggestions are transferred to the operating staff of the medical device from the central database, anonymized example images for setting the medical system, in each case fitting to the configuration suggestions, which represent the image quality to be expected and therefore impart to the operating staff an impression of the results to be expected, may also be provided. Thus, whether a medical question may be reliably answered may be established in advance based on the results. This procedure also owes debt to the fact that there are different “tastes” and “preferences” of the operating staff in the parameterization of imaging systems.

FIG. 2 shows a simplified block diagram of one embodiment of an arrangement with a medical system 1 and a central database 3 for optimized setting of the medical system 1. The first requirement specification data 11 is entered into the medical system 1 (e.g., an x-ray device), and the first requirement specification data 11 is transmitted to the central data analysis system 2 in a wired or wireless manner.

The core of the central data analysis system 2 is a database 3, in which a large amount of second configuration data 22 for the medical system 1 is stored together with the respective second requirement specification data 12 for the specific examinations and also with associated evaluations by experts. Hence, best-practice first configuration data 21 may be established from the database 3 for an optimum setting of the medical system 1.

The first configuration data 21 is transmitted from the central data analysis system 2 to the medical system 1, where the first configuration data 21 is displayed to the operating staff on a display unit 4. By confirming the displayed first configuration data 21 by the operating staff, the medical system 1 is set with the first configuration data 21 thus confirmed. The examination on a patient is carried out with the optimally selected settings. An advantage of the arrangement is that the arrangement is able to access a best-practice database 3 with a large number of second configuration data 22. Best-suited first configuration data for the medical question is selected by an intelligent algorithm.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for supporting a setting of a medical system, the method comprising:
identifying first requirement specification data relevant to a medical examination;
transmitting the first requirement specification data to a central data analysis system;
acquiring the first requirement specification data by the central data analysis system;
analyzing the first requirement specification data, the analyzing comprising comparing the first requirement specification data with stored second requirement specification data;
selecting best-fit first configuration data for setting the medical system based on the analyzing;
transmitting the first configuration data to the medical system; and
displaying the first configuration data on the medical system.

2. The method of claim 1, further comprising setting the medical system using the first configuration data after confirmation of the first configuration data by operating staff of the medical system.

3. The method of claim 1, wherein the selecting of the best-fit first configuration data is from a plurality of second configuration data stored in the central data analysis system, and
wherein the first requirement specification data is compared to the second requirement specification data and the associated second configuration data thereof.

4. The method of claim 3, wherein evaluation data by experts in relation to the second requirement specification data and the second configuration data are stored in the central data analysis system.

5. The method of claim 4, wherein evaluation data by experts in relation to the second requirement specification data and the second configuration data are stored in the central data analysis system for different medical examinations.

6. The method of claim 1, wherein the first requirement specification data comprise requirements for a medical examination to be carried out using the medical system.

7. The method of claim 6, wherein the first requirement specification data and the second requirement specification data comprise data with respect to a type of medical examination, data with respect to a medical question, data with respect to patient characteristics, and data with respect to an employed contrast agent.

8. The method of claim 7, wherein the data with respect to patient characteristics comprises data with respect to age, weight, or medical history.

9. The method of claim 1, further comprising continuously transmitting best-practice second configuration data evaluated by experts to the central data analysis system.

10. The method of claim 1, further comprising transmitting anonymized example images from the central data analysis system to the medical system,
wherein the anonymized example images represent image quality to be expected for the first configuration data and impart an impression of image recording results to be expected.

11. An arrangement comprising:
a medical system; and
a central data analysis system configured to:
receive first requirement specification data relevant to a medical examination;
analyze the first requirement specification data, the analysis comprising a comparison of the first requirement specification data with stored second requirement specification data;
select best-fit first configuration data for setting the medical system based on the analysis; and
transmit the first configuration data to the medical system; and
a database in the central data analysis system, in which the second requirement specification data and second configuration data are stored.

12. The arrangement of claim 11, wherein the medical system comprises an imaging device.

13. The arrangement of claim 11, wherein the selection of the best-fit first configuration data is from a plurality of second configuration data stored in the central data analysis system, and
wherein the central data analysis system is configured to compare the first requirement specification data to the second requirement specification data and the associated second configuration data thereof.

14. The arrangement of claim 13, wherein evaluation data by experts in relation to the second requirement specification data and the second configuration data are stored in the central data analysis system.

15. The arrangement of claim 14, wherein evaluation data by experts in relation to the second requirement specification data and the second configuration data are stored in the central data analysis system.

16. The arrangement of claim 11, wherein the first requirement specification data comprise requirements for a medical examination to be carried out using the medical system.

17. The arrangement of claim 16, wherein the first requirement specification data and the second requirement specification data comprise data with respect to a type of medical examination, data with respect to a medical question, data with respect to patient characteristics, and data with respect to an employed contrast agent.

18. The arrangement of claim 17, wherein the data with respect to patient characteristics comprises data with respect to age, weight, or medical history.
